(19) United States
(12) Patent Application Publication
(10) Pub. No.: US 2015/0292976 A1
(43) Pub. Date: Oct. 15, 2015

(54) METHOD AND SYSTEM FOR DETECTING LEAKS IN STEAM TURBINES

(71) Applicant: General Electric Company, Schenectady, NY (US)

(72) Inventors: James Jun Xu, Niskayuna, NY (US); Kevin Joseph Barb, Clifton Park, NY (US); Stephen Frank Francese, Malta, NY (US); Erich John Wollman, Simpsonville, SC (US)

(73) Assignee: General Electric Company, Schenectady, NY (US)

(21) Appl. No.: 14/249,591

(22) Filed: Apr. 10, 2014

(51) Int. Cl. G01M 3/38; H04N 5/33; H04N 7/18; G01M 15/14; G08B 21/20

(52) U.S. Cl. CPC G01M 3/38; G01M 15/14; G08B 21/20; H04N 7/183; H04N 5/33

(57) ABSTRACT

A system for detecting a leak in a steam turbine includes an infrared imaging device adapted to scan at least a portion of the steam turbine and communicate with a notification device. The infrared imaging device includes a cooled detector and a filter with a spectral response or bandpass between about 2.5 μm and about 8 μm. The leak will be indicated on the notification device, and the cooled detector is cooled to between about −80° C. and about −200° C. The steam turbine may be on-line during leak detection.

### BACKGROUND OF THE INVENTION

The subject matter disclosed herein generally relates to detection of leaks and more particularly to the detection of leaks in steam turbines.

Steam turbines have been commonly applied to generation of mechanical or electrical power for over one hundred years. The standard cycle is based upon a source of heat energy to generate steam, a turbine, a water or air cooled condenser for heat rejection, and a pumping system. Steam turbines are highly efficient as the expansive force of steam is the greatest of any of the common gases used for powering turbines. Steam turbines also benefit from use of an inexpensive, plentiful, and environmentally friendly working fluid. Thus, steam turbines are used in many applications.

However, achievement of the highest possible efficiencies requires that high temperatures and high pressures be utilized. In turn, robust operation of steam turbines under these conditions can be problematic. For example, inlet temperatures and pressures of up to 1400 degrees Fahrenheit (760° C.) and 5600 psi have been used. Common conditions for a modern boiler and steam turbine system are approximately 1050 F. (565 C.) and 2400-3500 psi. This type of system would normally incorporate “reheat” wherein the steam reenters the boiler for one or more stages of heat addition.

Typically, the first turbine section downstream of the boiler and up-stream of the first reheat is referred to as the high pressure (HP) turbine. Exhaust steam from the high pressure (HP) turbine is sent to the boiler for reheating along a cold reheat line. The reheated steam is typically heated to the initial inlet temperature before flowing into an intermediate pressure (IP) turbine. Exhaust from the IP turbine enters and flows through the low pressure (LP) turbine prior to exhaust to the condenser. Some systems may not incorporate the IP section, and more complex systems may have multiple reheat stages. Physical design of the system can vary dependent upon the application. Turbine sections can reside within the same casing, or multiple casings may exist.

Deformation of a steam turbine casing can allow steam to leak around the seals or at the tips of turbine buckets. This leakage reduces the amount of steam available to work on the downstream turbine buckets. Deformation of the casing can distort the seals which are intended to prevent the leakages of steam and gases.

Seals within a steam turbine generally include teeth on the static casing structure that interlace with the bucket covers. The gap between the teeth on the casing and the teeth on the buckets is narrow to prevent steam leakage over the covers of the blades. A steam turbine also has inter-stage seals between the stages of turbine buckets. The inter-stage seals prevent steam leakage through the turbine diaphragm packing that around the rotor shaft, and between each bucket stages. Deformation of the casing can distort the seals, and allow steam to escape through the seals and into and out of the casing.

Excessive forces due to pipe connections on a turbine casing can occur during the assembly or operation of a turbine. Pipe loads tend to be high during turbine startup when the pipes and turbine heat up. The heating of the pipes and turbine casing during startup results in differential thermal expansions in the pipes and casing. The differential expansions between the pipes and casing apply loads on the casing that distort the casing shell. During turbine startup, distortions in the casing typically exaggerate the turbine bucket and seal clearances. Excessive piping loads can also distort the turbine casing during turbine transient operations. Piping loads during transients, especially when cooling occurs in the pipes, tend to distort the turbine casing to reduce the clearances between the seals and buckets. If these clearances become too small, the stationary seals may “rub-out” as they scrap against the rotating buckets. Seals that rub-out do not provide effective sealing as they allow excessive steam leakage during steady state turbine operating conditions. Accordingly, excessive piping loads may damage and distort the seals between the casing and the buckets such that turbine performance is degraded. Additionally, it is known that potential leak spots may also include, borescope port flanges, stop valve flanges, turbine horizontal and vertical joints, crossover pipe flanges, intercept valve flanges, steam lead flanges, control valve flanges, steam seal regulators, mechanical hydraulic turbine control extraction pressure connections, and steam seal packing boxes.

Any undesired leakage of steam, either internal or external, will reduce the efficiency of the steam turbine. Externally leaking steam can also create safety hazards for people working near the turbine and create a relatively hot condition where the service life of electrically driven accessories, such as ventilation fans or pumps, may be shortened. Steam, and other substances that might be brought along with the steam, at very high pressure and/or temperature is not always visible to the naked eye, and more often than not the externally leaking steam is invisible to the naked eye. This makes it very difficult to detect steam leaks in steam turbines. Hydrostatic pressure testing is typically performed on new steam turbines during manufacture, but this method is not used for operating steam turbines. Sniffing type sensors are very labor intensive and are difficult to perform around operating steam turbines. Existing methods do not provide a remote, sensitive, accurate, safe, fast, or on-line steam turbine leak detection capability.

### BRIEF DESCRIPTION OF THE INVENTION

The disclosure provides a method and system for the remote, sensitive, accurate, safe, fast and on-line detection of a steam leak from a steam turbine that avoids health, environmental and safety concerns as well as avoiding unwanted outage time.

In accordance with one aspect of the invention, a system is provided for detecting a leak in a steam turbine. The system includes an infrared imaging device adapted to scan at least a portion of the steam turbine and communicate with a notification device. The infrared imaging device includes a cooled detector and a filter with a spectral response or bandpass between about 2.5 μm and about 8 μm. The leak will be indicated on the notification device, and the cooled detector is cooled to between about −80° C. and about −200° C. The steam turbine may be on-line during leak detection.

In another aspect, a method for detecting a leak in a steam turbine includes the steps of disposing an infrared imaging device having a cooled detector with a filter having a spectral response between about 2.5 μm to about 8 μm with a field of view encompassing at least a portion of the steam turbine. The steam turbine may be on-line. The detector and/or the filter are cooled to between about −80° C. and about −200° C. A scanning step scans at least a portion of the steam turbine with the infrared imaging device, and a filtering step filters radiation received by the infrared imaging device in a wavelength range of about 2.5 μm to about 8 μm. An establishing step establishes communication between the infrared imaging device and a notification device. An indicating step indicates the leak, the occurring leak or the suspected presence of a leak on the notification device if a leak or potential leak is present.

### BRIEF DESCRIPTION OF THE DRAWINGS

Other features and advantages of the present invention will be apparent from the following more detailed description of the preferred embodiment, taken in conjunction with the accompanying drawings which illustrate, by way of example, the principles of certain aspects of the invention.

FIG. 1 illustrates a schematic view of a leak detection system, according to an aspect of the present invention.

FIG. 2 is a chart of the absorption spectrum of CO₂, moisture and other species.

FIG. 3 illustrates a screenshot capture from the infrared imaging device and a display of notification device during leak detection, according to an aspect of the present invention.

FIG. 4 illustrates is a flow chart of a method for detecting a gas leak in a steam turbine, according to an aspect of the present invention.

FIG. 5 illustrates is a flow chart of the indicating step of FIG. 4, according to an aspect of the present invention.

FIG. 6 illustrates is a schematic of the notification device used for providing a warning/notification or displaying an image used during leak detection, according to an aspect of the present invention.

### DETAILED DESCRIPTION OF THE INVENTION

Aspects of the present disclosure include a system for detecting a gas leak in a generator through the introduction of an environmentally safe and non-corrosive tracer gas into the generator. An infrared imaging device adapted to display an image of the escaping tracer gas is provided.

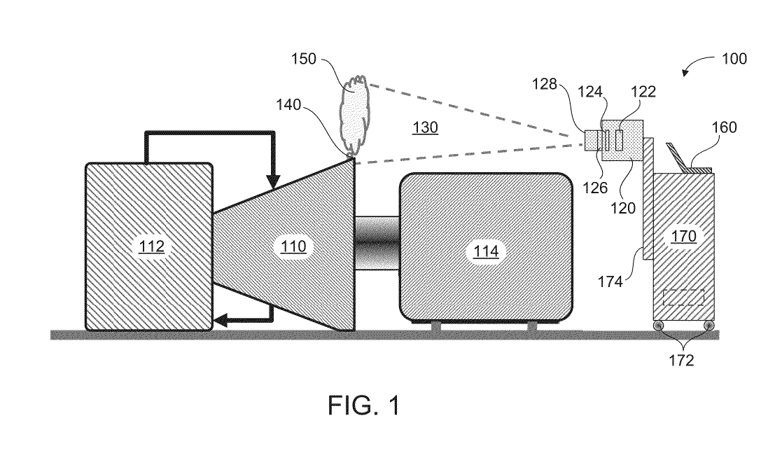

FIG. 1 illustrates a schematic of a system 100 for detecting a leak in a steam turbine 110. The steam turbine 110 is typically attached to a boiler 112 (or some other source of steam) and a load, such as generator 114. The steam turbine 110 may be on-line and/or in operating condition. The leak detection system 100 includes an infrared imaging device 120 adapted to scanning large or small portions of the on-line steam turbine. The infrared imaging device 120 may be a portable, hand held, midwave infrared camera with a cooled detector 122 having a spectral response or bandpass between about 2.5 μm to about 8 μm and may be further spectrally adapted to about 2.5 μm to about 3 μm, about 2.5 μm to about 2.8 μm, about 5 μm to about 8 μm, or about 6 μm to about 7 μm by use of a filter 124. The filter 124 restricts the wavelengths of emission of leaking volatile substances allowed to pass through to the detector 122 to a very narrow band called the band pass. This technique is called spectral adaptation. This makes the infrared imaging device 120 most responsive to gases typically found in leaks in steam turbines, but that are invisible to the naked eye. For example, steam (which is often invisible to the naked eye) is mostly comprised of water molecules (H₂O) and these molecules can be detected in the 2.5 μm to 3 μm and/or 5 μm to 8 μm wavelength ranges. In other aspects of the invention, a 3 μm to 5 μm midwavelength detector may also be used to detect water molecules as infrared emission of water molecules expands beyond 5 μm toward approximately 4.9 um. In yet another aspect of the invention, one or more filters may be used in series, for example, a first filter 124 with a spectral response of 2.5 μm to 8 μm may be stacked in series with a second filter 126 having a spectral response of 6 μm to 7 μm.

The cooled detector 122 of the infrared imaging device 120 may be cooled to about −80° C. to about −200° C. The infrared imaging device 120 may be an Integrated Cooler Detector Assembly (IDCA), to increase the sensitivity of remote imaging of steam or other gases. The thermal sensitivity is typically less than 20 mK, and more preferably less than 14 mK. The filters 124, 126 may be mounted on the outer lens 128, behind the outer lens 128, or inside the IDCA assembly for increased versatility or sensitivity. For example, if the filter is mounted inside the camera 120 body, the cooling effects will be more effective and the sensitivity will be increased. As non-limiting examples only, the detector 122 may be an HgCdTe (mercury cadmium telluride) detector with a spectral response of about 0.6 μm to about 25 μm cooled to about −80° C. to about −200° C., or an InSb (indium antimonide) detector with a spectral response of about 1 μm to about 8 μm, and cooled to about −200° C., or any other suitable cooled detector. The filter 124 and/or the filter 126 may be cooled to about 24° C., to about −40° C. or to about −200° C. As shown, the filter 126 will experience less cooling than filter 124, due to filter 126 being outside the main body of camera 120.

The infrared imaging device 120 may include an outer lens 128 that provides the infrared imaging device 120 with a field of view 130 encompassing all or a portion of the steam turbine 110. For example, the lens 128 may have a fixed focal length of about 14 mm to about 60 mm, or more. The lens 128 may also comprise a multi-focal lens having a range of focal lengths (e.g., a zoom lens). In general, most uses will be inside buildings, so a wider field of view (lower numerical focal length) may be preferred. However, a narrow field of view (higher numerical focal length) may be advantageous to pinpoint leaks in some applications. If there is a leak point 140 in the steam turbine the leaking gas (e.g., steam) will generate a leak gas cloud 150 emanating from the leak point 140. The leak or leak gas cloud 150 will be detected by the infrared imaging device 120.

The infrared imaging device 120 is adapted to communicate with a notification device 160. The notification device 160 may be a computer, a laptop, a tablet, a smartphone, a display, a speaker, a printer or a facsimile machine. The system 100 is configured to provide an indication, warning or notification of a potential leak by connecting the infrared imaging device (e.g., a camera) 120 to the notification device 160. When the notification device 160 is a computer, a laptop, a tablet, a smartphone, or a display the device 160 can display a static image or video of the steam turbine 110. This image or video will include a visible leak cloud 150, and in the case of a video, the cloud will be moving on the display of the device. Presence of a moving leak cloud 150 indicates a leak. This relative motion of the moving cloud 150, will facilitate identification of the leak cloud 150 against the substantially static or non-moving background image. Most external parts (e.g. outer housings, piping, etc.) of a steam turbine and associated machinery are non-moving, so a moving gas cloud will be readily identified in relation to the static components.

The infrared imaging device may be connected to the notification device via any suitable wired or wireless link. For example, the communication link between the infrared imaging device 120 and notification device 160 may be, but not limited to, a modulator/demodulator (modem; for accessing another device, system, or network), a radio frequency (RF), Wi-Fi, Bluetooth or other transceiver, a telephonic interface, a bridge, a router, a video cable, serial or parallel connectors/cables, a USB cable, or any other suitable communication connection. The notification device 160 and/or the infrared imaging device 120 may be supported by a mobile cart 170 that is configured to facilitate movement of the infrared imaging device 120 and the notification device 160 around the steam turbine 110 or other associated machinery. The cart 170 includes a plurality of wheels 172. The wheels 172 may be swivel caster wheels having a single, double, or compound wheel configuration. The wheels 172 are attached to the base of the cart 170 so as to enable the cart 172 to be easily moved. The wheels 172 may be comprised of rubber, plastic, nylon, aluminum, or stainless steel, or combinations thereof. An arm 174, which may be fixed, hinged or telescoping is connected to the cart 170 and allows the infrared imaging device 120 to be adjusted for height and position. The cart 170 may also function as a support for the notification device 160. The cart 170 may include a battery or battery bank 176 to provide power to the notification device 160 and infrared imaging device/camera 120. The battery bank 176 may be housed on or in the base of the cart 170 or it may be incorporated into the platform under notification device 160. In this manner, the system 100 is a self-contained and powered mobile system that can be easily moved around the steam turbine 110 and positioned to image specific regions of interest.

In operation, the infrared imaging device 120 displays an image of the leaking gas cloud 150 by rendering opaque (or visible) the gas in the leak gas cloud 150. For many gases, such as steam, the ability to absorb and to emit infrared radiation depends on the wavelength of the radiation. In other words, the degree of transparency varies with wavelength. There may be infrared wavelengths where they are essentially opaque due to absorption or emission. The infrared imaging device 120 is adapted to visualize the absorptive and emissive properties of steam and other potential gaseous substances produced when steam leaks penetrate through sealing or thermal insulation material wraps or glass or ceramic cloths of the steam turbine allowing the user the ability to discern the steam from its host environment. The filter 124 (and/or filter 126) is designed to transmit in an infrared spectrum that is coincident in wavelength with vibrational/rotational energy transitions of the molecular bonds of the steam. These transitions are typically strongly coupled to the field via dipole moment changes in the molecule, and are common to many types of gases and vapors. The device may be calibrated and tuned with the largest contrast possible using modes of absorption, emission, reflection or scattering so that the exact pressure, flow rate and temperature gradient of leaking steam, or tracer gas if from generator, can be identified from varying detection distances.

If the infrared imaging device 120 is directed at an steam turbine 110 without a steam or gas leak, objects in the field of view will emit and reflect infrared radiation through the filter 124 of the infrared imaging device 120. The filter 124 will allow only certain wavelengths of radiation through to the detector 122 and from this the infrared imaging device 120 will generate an uncompensated image of radiation intensity. If there is a leak within the field of view 130 of the infrared imaging device 120 such as at leak point 180, a leaking gas or leaking steam cloud 150 will be generated between the steam turbine 110 and the field of view 130 of the infrared imaging device or camera 120. The leaking steam cloud 150 will contain molecules that absorb or emit radiation in the band pass range of the filter 124 (and/or filter 126), and consequently the amount of radiation passing through the cloud and returning to the detector 122 will be reduced, thereby making the steam cloud 150 visible through the infrared imaging device 120.

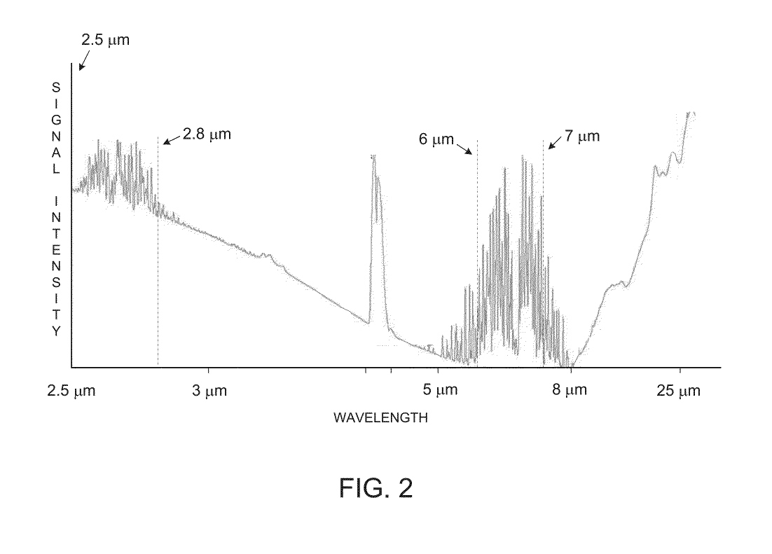

FIG. 2 illustrates the infrared signal intensity of various gases over various wavelengths. In the wavelength range of 2.5 μm to less than 3 μm, and 5 μm to 8 μm water (H₂O) molecules have a strong infrared signal. The infrared signal intensity of gaseous or non-gaseous hydrocarbons is fairly linear over the wavelength range of 3 μm to 5 μm, except for a peak at about 4.2 μm to about 4.5 μm. This peak at 4.2 μm to 4.5 μm is due to absorption or emission of carbon dioxide (CO₂) gaseous or non-gaseous molecules. This means that steam will be easy to distinguish from background radiation in this relatively narrow infrared band (i.e., 2.5 μm to 8 μm), assuming the detector is tuned to this wavelength band. The difficulty arises in that most thermal infrared detectors can't detect or distinguish or image infrared signals or gaseous substances in this band, due to overwhelming background interference. However, according to an aspect of the present invention, a cooled infrared detector or infrared imaging device 120 having a filter of 2.5 μm to 8 μm, 2.5 μm to 3 μm, 2.5 μm to 2.8 μm, 5 μm to 8 μm or 6 μm to 7 μm, will be able to detect the water molecules in the leaking steam cloud 150. The cooled infrared detector 122 increases the sensitivity and reduces photon interference that typically plagues other infrared detectors, and the band pass filter (124 and/or 126) eliminates interference from other commonly present gases or molecules by focusing on the high contrast (or intensity) signal of water molecules and other potential gaseous substances in leaking steam.

The infrared imaging device 120 was described previously, and is a cooled infrared imaging detector, such as an IDCA camera, and may be mounted to cart 170 or on arm 174, The imaging device 120 may also be removed from cart 170 and moved independently around the steam turbine or associated machinery by an operator or technician. The notification device 160 may take the form of a special or general purpose digital computer, such as a personal computer (PC; IBM-compatible, Apple-compatible, Android or otherwise), laptop, netbook, tablet, smartphone, workstation, minicomputer, printer, fax machine or any other suitable computer and display device. The notification device 160 receives image data from the infrared imaging device 120 and displays or processes the result in real time, or near real time.

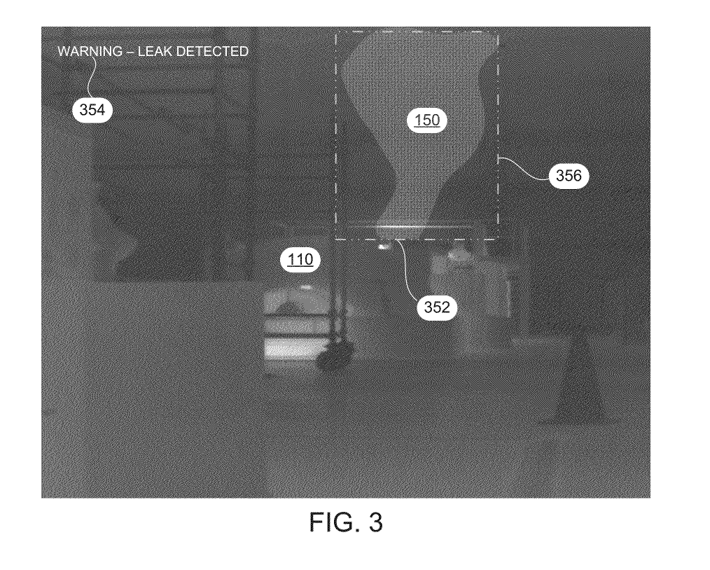

FIG. 3 illustrates a screenshot capture from the infrared imaging device 120 and a display of notification device 160 during leak detection. A portion of the steam turbine 110 is shown a cloud 150 can be seen emanating from the top of the steam turbine. The leak begins at point 352 and the gas cloud 150 is blowing or drifting upward (as shown). In this example, the steam turbine 110 is in operation and/or generating power (or on-line). The leaking steam cloud 150 is invisible to the naked eye, but is made visible on a display of notification device 160 via infrared imaging device 120 and the appropriate filters (e.g., a 2.5 μm to 3 μm, or 5 μm to 8 μm bandpass infrared optical filter). In the example of FIG. 3, a 5 μm to 8 μm bandpass infrared optical filter was used. FIG. 3 illustrates a static photograph (or screen capture), but even in a still image it will be clear that something is concerning in the image, as the leaking steam cloud 150 should not be there in a non-leaking steam turbine. The camera 120 and notification device 160 can be used to display video images as well, and with a video display the steam cloud 150 can be seen to physically move on the display of notification device 160. The relative motion between the moving steam cloud 150 and the static (or non-moving turbine or generator parts) makes it very easy for a person to identify that a leak is occurring and where the leak begins. In this example, the cart 170 can be re-positioned to more closely examine the top portion of the steam turbine 110 to pinpoint the exact leak location.

The notification device 170 may also display a warning or notification that a potential leak has been detected. An optional text message 354 or display can be shown on the notification device 160. An audible signal (e.g., a beep or siren) can be output from a speaker associated with the notification device 170. A border 356 could be drawn around the potential leak cloud 150. A fax could be sent to a fax machine indicating the a leak has been detected. A text message (or image or video or alarm) could be sent to a smartphone, tablet or computer indicating leak detection. A signal could also be sent to a remote or local monitoring site to indicate that a leak was detected.

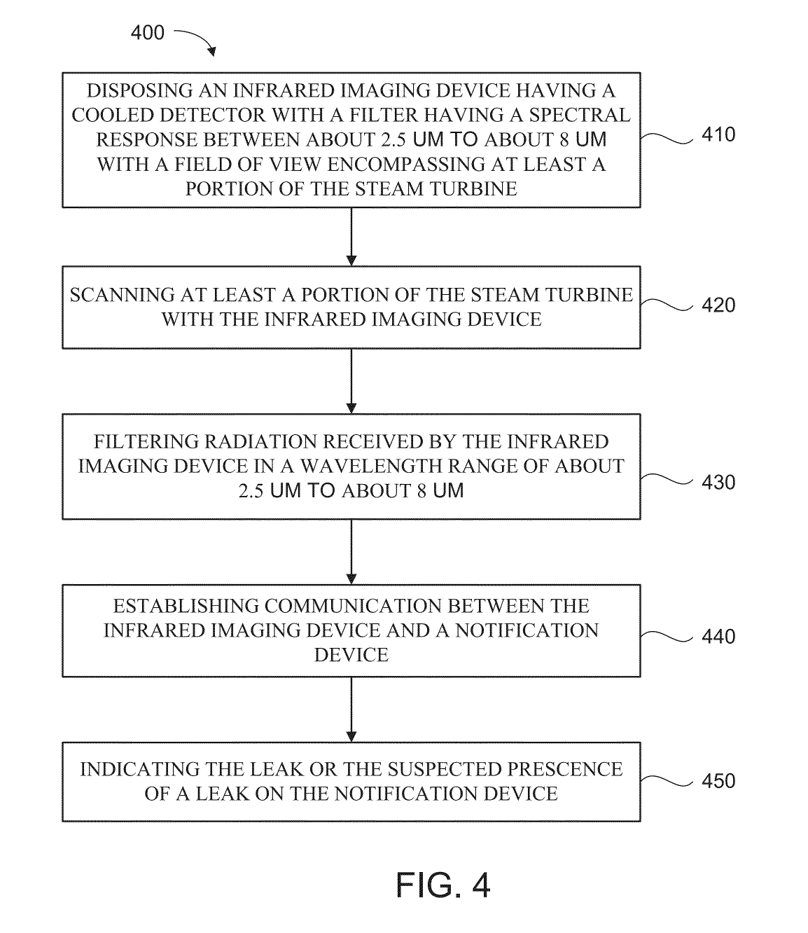

FIG. 4 illustrates a flow chart of a method 400 for detecting a leak in a steam turbine 110, according to an aspect of the present invention. The method 400 includes the step of disposing 410 an infrared imaging device 120 having a cooled detector 122 with a filter 124 having a spectral response between about 2.5 μm to about 8 μm with a field of view encompassing at least a portion of the steam turbine 110. At least one of the detector 122 or the filter 124 is cooled to between about −80° C. and about −200° C. The disposing step 410 may also include using a movable cart 170 that contains one or both of the infrared imaging device 120 or the notification device 160 to position the infrared imaging device 120 or the notification device 160 around the steam turbine 110.

A scanning step 420 scans at least a portion of the steam turbine 110 with the infrared imaging device 120. For example, the infrared imaging device 120 (e.g., an infrared camera) is turned on and oriented so that its field of view covers all or a portion of the steam turbine 110. This usually includes areas of suspected leaks first, but could include large portions or the entire steam turbine, if possible. The infrared imaging device 120 will output one or more frames of image data, and a video signal will include multiple frames of image data, which may be at 10, 30 or 60 frames per second (or any other suitable frames per second rate).

A filtering step 430 filters the radiation or emission received by the infrared imaging device 120 in a wavelength range of about 2.5 μm to about 8 μm, which allows the water molecules in steam to be detected. If desired one or more filters 124, 126 may be used to filter the radiation, and the filters may have bandpass ranges (or spectral responses) of 5 μm to 8 μm, 6 μm to 7 μm, 2.5 μm to 3 μm or 2.5 μm to 2.8 μm. Alternatively, a multi-bandpass filter could be used having multiple bandpass ranges, e.g., 2.5 μm to 2.8 μm and 6 μm to 7 μm. The filters may be mounted on a filter wheel in an infrared imaging device.

An establishing step 440 establishes communication between the infrared imaging device 120 and the notification device 160. The notification device 160 may be a special or general purpose digital computer, such as a personal computer (PC; IBM-compatible, Apple-compatible, Android or otherwise), laptop, netbook, tablet, smartphone, workstation, minicomputer, printer, facsimile machine a speaker or any other suitable computer and/or display device. The communication between the infrared imaging device 120 and notification device 160 may be established over a modulator/demodulator (modem; for accessing another device, system, or network), a radio frequency (RF), Wi-Fi, Bluetooth or other transceiver, a telephonic interface, a bridge, a router, a video cable, a USB cable or any other suitable wired or wireless link.

A indicating step 450 indicates the leak 150 or the suspected presence of a leak on the notification device 160. If the notification device 160 is, or includes, a display, then the leak 150 may be shown on the display as a static or video image (e.g., as illustrated in FIG. 3). In a video display, the leak will appear as a moving cloud 150 emanating from the steam turbine that is either lighter or darker than the background images. The moving aspect of cloud 150 makes it very easy for a person to identify the cloud and that a leak exists. If no leak is present, then no leak cloud will be seen on the display. In addition, the steam turbine and other associated machine elements (e.g., the generator) may also be identified on the display, and this also facilitates the identification of the leak location.

A warning or a notification may also be provided of a potential leak. Referring back to FIG. 3, a warning 354 may take the form of a text message on the display of the notification device 160. The warning 354 can be displayed in a high contrast color or made to flash on and off to draw the attention of the user. The warning/notification could be a sound, such as a beep or siren, emitted from a speaker. The warning/notification could also be a high-contrast colored border 356 drawn around the suspected leak location or leak cloud. This will draw the user's attention to more closely inspect the region inside the border 356. In a grayscale image, the high-contrast color could be white or red, or any other suitable color that facilitates identification. Other notifications/warnings may include a fax sent to a facsimile machine indicating that a leak has been detected or a printed page could be generated and sent to a printer, a text message or video image sent to a smartphone, tablet or computer indicating leak detection, or an electronic, analog or digital signal sent to a remote or local monitoring site to indicate that a leak was detected.

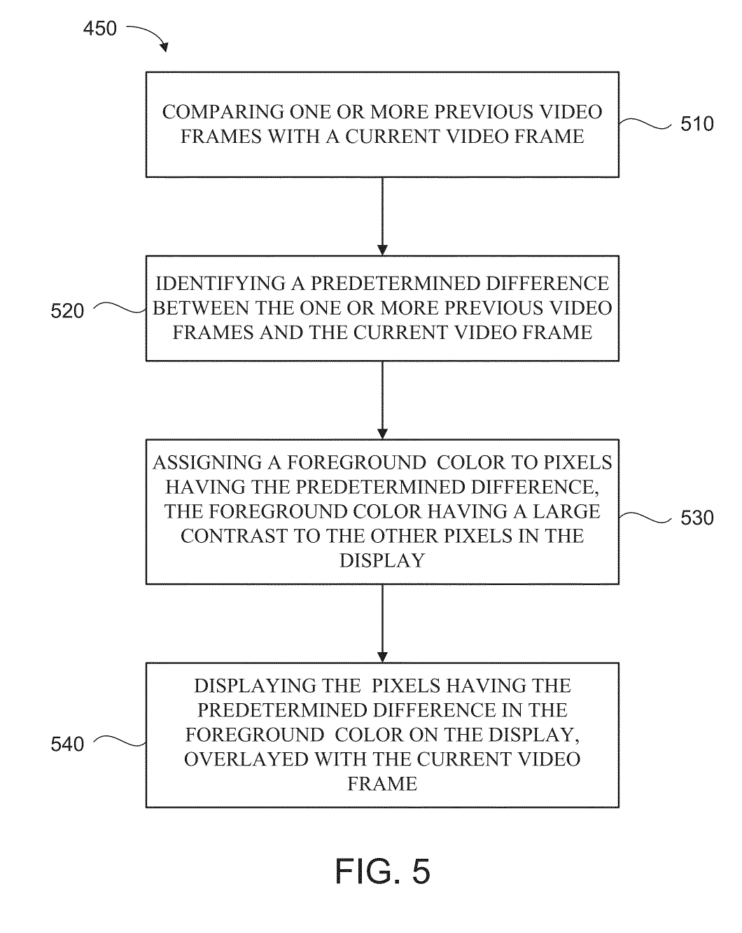

FIG. 5 illustrates a flowchart of optional steps for use with the indicating step 450 of FIG. 4. The indicating step 450 may further include a comparing step 510 that compares one or more previous video frames with a current video frame. An identifying step 520 identifies a predetermined difference between the one or more previous video frames and the current video frame. An assigning step 530 assigns a foreground color to pixels having the predetermined difference, and the foreground color has a large contrast to the other pixels in the display. For example, if the primary color scheme of the image is grayscale (or black and white), then the foreground color may be red, which would provide a large contrast and make the moving red pixels easily visible against a grayscale background. A display step 540 is used to display the pixels having the predetermined difference in the foreground color on the display, overlaid with the current video frame. In this manner, it will be easy for a user (or technician) to identify if a leak is occurring, and where the leak is occurring.

Alternatively, the display step 540 may include a comparing step that compares one or more previous video frames with a current video frame, and an identifying step that identifies a predetermined difference between the one or more previous video frames and the current video frame. An assigning step assigns a foreground color to a border surrounding the pixels having the predetermined difference, and the foreground color has a large contrast to the other pixels in the display. A displaying step displays the border, around the pixels having the predetermined difference, in the foreground color on the display, where the border overlaid with the current video frame. For example, if the primary color scheme of the image is grayscale (or black and white), then the border color may be red, green or yellow, which would provide a large contrast and make the moving red, green or yellow pixels easily visible against a grayscale background. Any color may be chosen to provide contrast, as desired in the specific application or by the needs of the specific user. For example, a color blind person may choose a specific color that has a large contrast from their perception.

The display step 540 may also include a comparing step that compares one or more video frames with an adjacent video frame, and an identifying step that identifies a predetermined difference between the one or more video frames and the adjacent video frame. An assigning step assigns at least one of, a foreground color to pixels having the predetermined difference or a foreground color to a border surrounding the pixels having the predetermined difference. The foreground color has a large contrast to other pixels in the display. A displaying step displays at least one of, the pixels having the predetermined difference in the foreground color on the display, or the border in the foreground color on the display around the pixels having the predetermined difference, overlaid with a current video frame.

The signal from the infrared imaging device 120 may also be electronically processed to analyze the signal to determine if motion above a predetermined threshold has been detected. Many cameras output an analog signal or digital bit stream. In the digital bit stream example, this bit stream could be broken up into frames and each frame could be digitally analyzed for pixels having motion. The brightness of each pixel, or a group of pixels could be compared to previous frames and if their brightness (or color) change exceeded a predetermined change amount, then a leak could be present in the steam turbine. As non-limiting examples only, if the brightness and/or color change of one or more pixels varies by more than 10%, then a threshold could be crossed that indicates a potential leak. 10% is merely one example, and other values such as 5%, 20%, 30% or more could be employed as desired in the specific application.

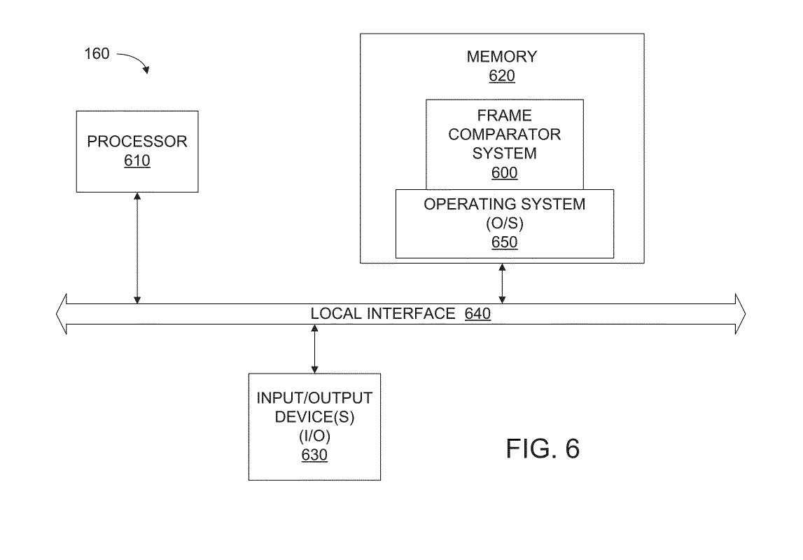

The notification device 160 and frame comparator system 600 of the invention may be implemented in software (e.g., firmware), hardware, or a combination thereof. In the currently contemplated best mode, the frame comparator system 600 is implemented in software, as an executable program, and is executed by a special or general purpose digital computer, such as a personal computer (PC; IBM-compatible, Apple-compatible, or otherwise), laptop, tablet, smartphone, workstation, minicomputer, or mainframe computer. An example of a general purpose computer that can implement the frame comparator system 600 of the present invention is shown in FIG. 6.

Generally, in terms of hardware architecture, as shown in FIG. 6, the computer or display 160 includes a processor 610, memory 620, and one or more input and/or output (I/O) devices 630 (or peripherals) that are communicatively coupled via a local interface 640. The local interface 640 can be, for example but not limited to, one or more buses or other wired or wireless connections, as is known in the art. The local interface 640 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 610 is a hardware device for executing software, particularly that stored in memory 620. The processor 610 can be any custom made or commercially available processor, a central processing unit (CPU), an auxiliary processor among several processors associated with the computer 160, a semiconductor based microprocessor (in the form of a microchip or chip set), a macroprocessor, or generally any device for executing software instructions. Non-limiting examples of suitable commercially available microprocessors are as follows: a PA-RISC series microprocessor from Hewlett-Packard Company, a core 2 or i7 series microprocessor from Intel Corporation, a PowerPC microprocessor from IBM, a Sparc microprocessor from Sun Microsystems, Inc, or a 68xxx series microprocessor from Motorola Corporation.

The memory 620 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 620 may incorporate electronic, magnetic, optical, and/or other types of storage media. Note that the memory 620 can have a distributed architecture, where various components are situated remote from one another, but can be accessed by the processor 610.

The software in memory 620 may include one or more separate programs, each of which comprises an ordered listing of executable instructions for implementing logical functions. In the example of FIG. 6, the software in the memory 620 includes the frame comparator system 600 in accordance with the present invention and a suitable operating system (O/S) 650. A nonexhaustive list of examples of suitable commercially available operating systems 650 is as follows: (a) a Windows operating system available from Microsoft Corporation; (b) a Netware operating system available from Novell, Inc.; (c) a Macintosh operating system available from Apple Computer, Inc.; (e) a UNIX operating system, which is available for purchase from many vendors, such as the Hewlett-Packard Company, Sun Microsystems, Inc., and AT&T Corporation; (d) a LINUX operating system, which is freeware that is readily available on the Internet; (e) a run time Vxworks operating system from WindRiver Systems, Inc.; or (f) an appliance-based operating system, such as that implemented in handheld computers or personal data assistants (PDAs) (e.g., PalmOS available from Palm Computing, Inc., and Windows CE available from Microsoft Corporation). The operating system 650 essentially controls the execution of other computer programs, such as the frame comparator system 600, and provides scheduling, input-output control, file and data management, memory management, and communication control and related services. In addition, a graphics processing unit (not shown) resident on a motherboard (not shown) may also be used to implement the frame comparator system 600.

The frame comparator system 600 is a source program, executable program (object code), script, or any other entity comprising a set of instructions to be performed. When a source program, then the program needs to be translated via a compiler, assembler, interpreter, or the like, which may or may not be included within the memory 620, so as to operate properly in connection with the O/S 650. Furthermore, the frame comparator system 600 can be written as (a) an object oriented programming language, which has classes of data and methods, or (b) a procedure programming language, which has routines, subroutines, and/or functions, for example but not limited to, C, C++, Pascal, Basic, Fortran, Cobol, Perl, Java, and Ada.

The I/O devices 630 may include input devices, for example but not limited to, a keyboard, mouse, scanner, microphone, camera, infrared imaging device or camera, etc. Furthermore, the I/O devices 630 may also include output devices, for example but not limited to, a printer, display, etc. Finally, the I/O devices 630 may further include devices that communicate both inputs and outputs, for instance but not limited to, a modulator/demodulator (modem; for accessing another device, system, or network), a radio frequency (RF), Wi-Fi, Bluetooth or other transceiver, a telephonic interface, a bridge, a router, etc.

If the computer 160 is a PC, workstation, or the like, the software in the memory 620 may further include a basic input output system (BIOS) (omitted for simplicity). The BIOS is a set of essential software routines that initialize and test hardware at startup, start the O/S 650, and support the transfer of data among the hardware devices. The BIOS is stored in ROM so that the BIOS can be executed when the computer 160 is activated.

When the computer 160 is in operation, the processor 610 is configured to execute software stored within the memory 620, to communicate data to and from the memory 620, and to generally control operations of the computer 160 pursuant to the software. The frame comparator system 600 and the O/S 650, in whole or in part, but typically the latter, are read by the processor 610, perhaps buffered within the processor 610, and then executed.

When the frame comparator system 600 is implemented in software, as is shown in FIG. 6, it should be noted that the frame comparator system 600 can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The frame comparator system 600 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the frame comparator system 600 is implemented in hardware, the frame comparator system 600 can implemented with any or a combination of the following technologies, which are each well known in the art: a graphics processing unit, a video card, a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The system and method according to the present invention demonstrates substantially improved results that were unexpected because a leak can now be detected in an on-line steam turbine. Previously, the steam turbine had to be off-line and a time consuming and expensive process was needed for leak detection, and/or the steam leak was effectively invisible to the naked eye. The substantially improved results occur by scanning an on-line or operating steam turbine and by using an infrared imaging device configured to detect steam (or other constituents in steam) leaking from the steam turbine.

Where the definition of terms departs from the commonly used meaning of the term, applicant intends to utilize the definitions provided below, unless specifically indicated. The terminology used herein is for the purpose of describing particular embodiments only and is not intended to be limiting of the invention. For example, the above-described embodiments (and/or aspects thereof) may be used in combination with each other. In addition, many modifications may be made to adapt a particular situation or material to the teachings of the invention without departing from its scope. For example, the ordering of steps recited in a method need not be performed in a particular order unless explicitly stated or implicitly required (e.g., one step requires the results or a product of a previous step to be available). Where the definition of terms departs from the commonly used meaning of the term, applicant intends to utilize the definitions provided herein, unless specifically indicated. The singular forms “a”, “an” and “the” are intended to include the plural forms as well, unless the context clearly indicates otherwise. It will be understood that, although the terms first, second, etc. may be used to describe various elements, these elements should not be limited by these terms. These terms are only used to distinguish one element from another. The term “and/or” includes any, and all, combinations of one or more of the associated listed items. The phrases “coupled to” and “coupled with” contemplates direct or indirect coupling.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements.

1. A system for detecting a leak in a steam turbine, the system comprising:
an infrared imaging device adapted to scan at least a portion of the steam turbine and communicate with a notification device, the infrared imaging device comprising a cooled detector and a filter with a spectral response or bandpass between about 2.5 μm and about 8 μm; and
wherein the leak will be indicated on the notification device, and wherein the cooled detector is cooled to between about −80° C. and about −200° C.

2. The system of claim 1, wherein the steam turbine is on-line.

3. The system of claim 1, wherein the spectral response of the filter is between about 5 μm and about 8 μm, or between about 6 μm and about 7 μm.

4. The system of claim 1, wherein the spectral response or bandpass of the filter is between about 2.5 μm and about 3 μm, between about 2.5 μm and about 2.8 μm, or between 3 μm and 5 μm.

5. The system of claim 1, wherein the cooled detector is at least one of:
an HgCdTe detector cooled to between about −80° C. and about −200° C., or
an InSb detector cooled to about −200° C.

6. The system of claim 1, wherein the filter is cooled to about 24° C. to about −200° C.

7. The system of claim 1, further comprising a movable cart that is configured to facilitate movement of the infrared imaging device and notification device around the steam turbine.

8. The system of claim 1, the notification device further comprising at least one of:
a computer, a laptop, a tablet, a smartphone, a display, a speaker, a printer or a facsimile machine.

9. The system of claim 1, the system configured to provide a warning or notification on the notification device to indicate a potential leak or an occurring leak.

10. The system of claim 9, wherein the warning or the notification is at least one of:
a plurality of high-contrast pixels, a high-contrast border around a suspected leak location, a video image having a high-contrast portion to indicate the suspected leak location, a text message, an e-mail message, or an audible signal.

11. A method for detecting a leak in a steam turbine, the method comprising:
disposing an infrared imaging device having a cooled detector with a filter having a spectral response between about 2.5 μm to about 8 μm with a field of view encompassing at least a portion of the steam turbine, wherein at least one of the detector and the filter is cooled to between about −80° C. and about −200° C.;
scanning at least a portion of the steam turbine with the infrared imaging device;
filtering radiation received by the infrared imaging device in a wavelength range of about 2.5 μm to about 8 μm;
establishing communication between the infrared imaging device and a notification device; and
indicating the leak or the suspected presence of a leak on the notification device if the leak or a potential leak is present.

12. The method of claim 11, wherein the disposing step includes using a movable cart that contains at least one of the infrared imaging device or the notification device to position the infrared imaging device or the notification device around the steam turbine.

13. The method of claim 11, wherein the filtering step includes filtering the radiation with the filter having a spectral response between about 5 μm and about 8 μm.

14. The method of claim 13, wherein the filtering step includes filtering the radiation with the filter having a spectral response between about 6 μm and about 7 μm.

15. The method of claim 11, the notification device further comprising at least one of, a computer, a laptop, a tablet, a smartphone, a display, a speaker, a printer or a facsimile machine and the step of:
providing a warning or a notification on the notification device to indicate a potential leak.

16. The method of claim 15, wherein the notification device is at least one of a computer, a laptop, a tablet, a smartphone, a display; and
displaying an image of the portion of the steam turbine from the infrared imaging device on the notification device, and wherein the leak will be indicated by a cloud leaking from the steam turbine on the notification device.

17. The method of claim 16, wherein the displaying step includes displaying a moving cloud, or a video image of the moving cloud, on the notification device if a leak is detected.

18. The method of claim 17, the display step further comprising:
comparing one or more previous video frames with a current video frame;
identifying a predetermined difference between the one or more previous video frames and the current video frame;
assigning a foreground color to pixels having the predetermined difference, the foreground color having a large contrast to other pixels in the current video frame;
displaying the pixels having the predetermined difference in the foreground color, overlaid with the current video frame.

19. The method of claim 17, the display step further comprising:
comparing one or more previous video frames with a current video frame;
identifying a predetermined difference between the one or more previous video frames and the current video frame;
assigning a foreground color to a border surrounding pixels having the predetermined difference, the foreground color of the border having a large contrast to other pixels in the current video frame;
displaying the border around the pixels having the predetermined difference in the current video frame, and wherein the border is overlaid with the current video frame.

20. The method of claim 17, the display step further comprising:
comparing one or more video frames with a substantially adjacent video frame;
identifying a predetermined difference between the one or more video frames and the substantially adjacent video frame;
assigning at least one of, a foreground color to pixels having the predetermined difference, or a foreground color to a border surrounding the pixels having the predetermined difference, where the foreground color has a large contrast to other pixels in a current video frame;
displaying at least one of, the pixels having the predetermined difference in the foreground color, or the border in the foreground color around the pixels having the predetermined difference, overlaid with the current video frame.
